(19) United States
(12) Patent Application Publication
(10) Pub. No.: US 2003/0115555 A1
(43) Pub. Date: Jun. 19, 2003

(54) A METHOD AND APPARATUS FOR INTEGRATING BOUNDARY-SCAN MULTIPLEXER FUNCTIONALITY WITHIN A PAD DRIVER

(76) Inventor: LARRY WISSEL, WILLISTON, VT (US)

Correspondence Address: IBM MICROELECTRONICS, INTELLECTUAL PROPERTY LAW, 1000 RIVER STREET, 972 E, ESSEX JUNCTION, VT, 05452, US

(21) Appl. No.: 09/439,786

(22) Filed: Nov. 12, 1999

(51) Int. Cl. G06F 17/50

(52) U.S. Cl. 716/4

(57) ABSTRACT

A method and apparatus for implementing Boundary-Scan functionality (i.e. the selection of either functional or test data) while eliminating undesirable delay during the selection of the functional data.

### BACKGROUND

### TECHNICAL FIELD OF THE PRESENT INVENTION

The present invention generally relates to methods and apparatuses that improve the performance of a pad driver, and more specifically, that integrate the functionality of a Boundary-Scan multiplexer within a pad driver.

### BACKGROUND OF THE PRESENT INVENTION

The electronic industry is in a state of evolution spurred by the recent changes in technology which have allowed greater functionality in smaller devices. This has resulted in the explosion of new found uses for such small devices (e.g. medical, monitoring etc.), as well as greater functionality in increasingly smaller electronic devices.

The evolution has caused electronic devices to become an inseparable part of our society. Consumers are now buying and demanding electronic devices which are smaller, more powerful, and faster at unprecedented rates. These demands are constantly driving the electronic industry to exceed limitations which were previously considered unsurpassable.

One area ripe for improvement is the current implementations of Boundary-Scan circuitry in connection with Pad drivers. In general, the Boundary-Scan circuitry allows a designer/tester to select either test data or functional data as input to a desired circuit. An example of such an implementation is illustrated in the IEEE Standard Test Access Port and Boundary-Scan Architecture IEEE Std 1149.1-1990 and IEEE Std 1149.1a-1993.

The current implementations typically include a multiplexer, which is external to the pad driver, that provides the ability to select either test or functional data for input to the pad driver. Unfortunately, the inclusion of the multiplexer in the path of the functional data introduces extra delay.

It would, therefore, be a distinct advantage to have a method and system that could provide the Boundary-Scan functionality without the introduction of additional delay when functional data is selected. The present invention provides such a method and apparatus.

### SUMMARY OF THE PRESENT INVENTION

The present invention is a method and system for providing the functionality of a Boundary-Scan multiplexer within a pad driver while avoiding the delay that is typically introduced into the path of the functional data.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a schematic diagram illustrating a portion of a circuit 100 for driving a pad 106 with an external multiplexer 102 for Boundary-Scan purposes;

FIG. 2 is a schematic diagram illustrating in greater detail the various components of the Three State Driver (TSD) 104 of FIG. 1; and

FIG. 3 is a schematic diagram illustrating a Three State Driver (TSD) 300 constructed according to the teachings of a preferred embodiment of the present invention.

### DETAILED DESCRIPTION OF THE PREFERRED EMBODIMENT OF THE PRESENT INVENTION

In the following description, numerous specific details are set forth in order to provide a thorough understanding of the present invention. However, it will be obvious to those of ordinary skill in the art that the present invention can be practiced with different details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention, and are within the skills of persons of ordinary skill in the relevant art.

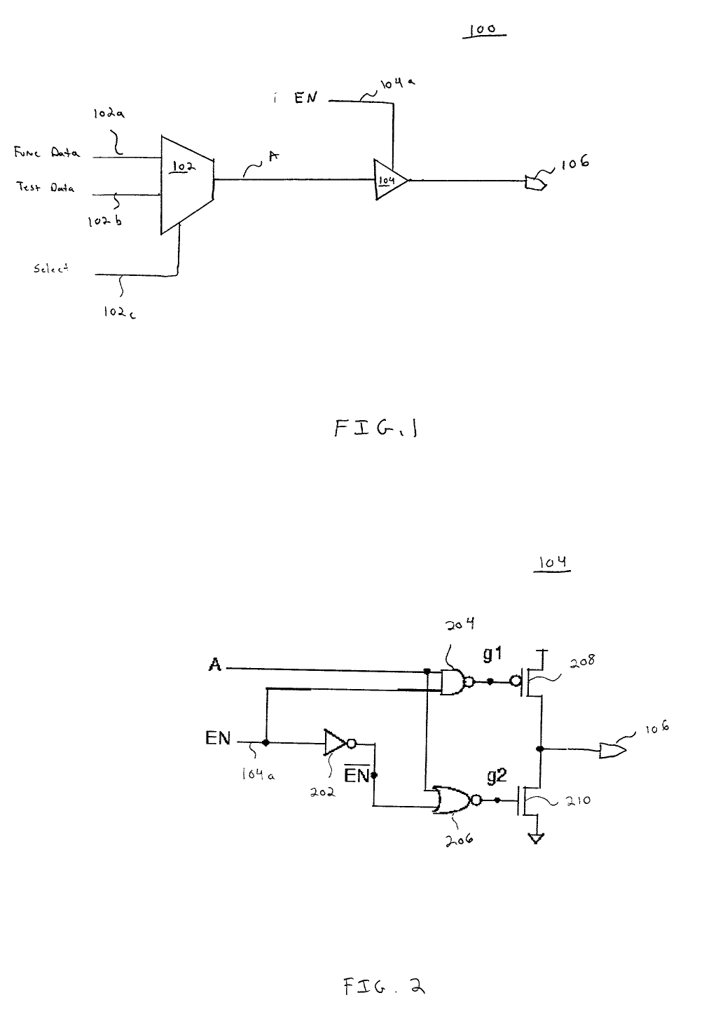

FIG. 1 is a schematic diagram illustrating a portion of a circuit 100 for driving a pad 106 with an external multiplexer 102 for Boundary-Scan purposes. The circuit 100 also includes a Three State Driver (TSD) 104. The multiplexer 102 is used to select either functional data 102a or test data 102b via select line 102c. The output of the multiplexer 102 is labeled as A. The test data 102b is used in Boundary-Scan testing techniques as is well known in the art. An enable signal EN 104a is used for enabling the various states of the TSD 104. The various components of the TSD 104 are explained in greater detail in connection with the description of FIG. 2.

FIG. 2 is a schematic diagram illustrating in greater detail the various components of the Three State Driver (TSD) 104 of FIG. 1. The TSD 104 includes an inverter 202, a nand gate 204, a nor gate 206, and pull-up PMOS 208/pull-down NMOS 210 transistors. The output A is fed into the nand gate 204 and nor gate 206. The enable 104a is fed into the nand gate 204 and inverter 202. The output of the invertor 202 is fed into the Nor gate 206.

The output of Nand gate 204 is connected to the gate of PMOS 208, and the output of Nor gate 206 is connected to the gate of NMOS 210. Nand gate 204 and Nor gate 206 are constructed so as to provide their functionality while only having two transistors in series with one another. More specifically, Nor gate 206 has two PMOS transistors in series to pull node g2 to high (Vdd), and Nand gate 204 has two NMOS transistors to pull node g1 to low (Vss).

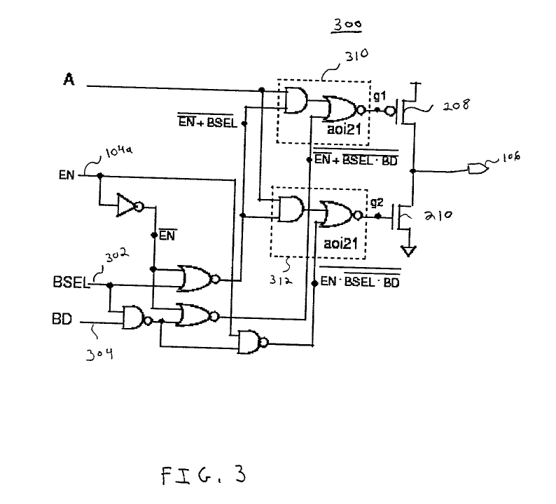

In the circuit of 100, the use of the external multiplexer 102 for selection of either the functional data 102a or test data 102b introduces extra delay. Although the extra delay is often acceptable for the test data 102b, this extra delay is not desirable in the path of the functional data 102a. The ability to select between either the functional data 102a or test data 102b for conducting Boundary-Scans is indispensable. The present invention provides the ability to select either the functional data 102a or test data 102b while eliminating the introduction of extra delay into the functional data path 102a as explained in greater detail in connection with FIG. 3.

FIG. 3 is a schematic diagram illustrating a Three State Driver (TSD) 300 constructed according to the teachings of a preferred embodiment of the present invention. TSD 300 includes a functional data path A 102d, a test data path BD 304, an enable (EN) 104a signal path, a test data select (BSEL) 302 signal path, and additional circuitry (invertors, and, nand, and nor gates, PMOS 208, and NMOS 210). The EN signal 104a enables the various states of the TSD 300. The BDSEL 302 signal determines whether function data A 102d or test data (BD 304) are selected for input to the pad 106. PMOS 208 and NMOS 210 function in the same fashion as previously described in connection with FIG. 2.

In order to provide the ability to select either the functional data 102d or test data 304 without introducing delay into the functional data 102d path, any circuitry connecting to the gates of PMOS 306 or NMOS 308 must have the same or less number of transistors in series as the nand gate 204 and nor gate 206 of FIG. 2. In the preferred embodiment, the circuit elements used in portions 310 and 312 of the TSD 300 meet this criteria. Specifically, an And-Or-Invert gate of type AOI21.

The Boolean logic used to create the preferred embodiment of FIG. 3 from the g1 and g2 node standpoint is illustrated below in Table I.

TABLE I
$\begin{matrix}\overline{g1} = en L2 \overline{BSEL} + en BD BSEL \\ g1 = \overline{en L2 \overline{BSEL} + en BD BSEL} \\ = \overline{( en \overline{BSEL} ) L2 + [ en ( BD BSEL ) ]} \\ = \overline{\overline{( \overline{en} + BSEL )} L2 + [ ( \overline{en} + \overline{( BD BSEL )} ]} \\ ( g1 = PMCS gate ) \\ \overline{g2} = \overline{en} + en \overline{BSEL} L2 + en BD BSEL \\ g2 = \overline{\overline{en} + ( en \overline{BSEL} ) L2 + ( en BD BSEL )} \\ = \overline{( en \overline{BSEL} ) L2 + [ \overline{en} + ( en BD BSEL ) ]} \\ = \overline{( en \overline{BSEL} ) L2 + [ en ( \overline{en BD BSEL )} ]} \\ = \overline{( en \overline{BSEL} ) L2 + [ en ( \overline{en} + \overline{BD BSEL} ) ]} \\ = \overline{\overline{( \overline{en} + BSEL )} L2 + \overline{( en \overline{BD BSEL} )}} \\ ( g2 = NMCS gate )\end{matrix}$

It is thus believed that the operation and construction of the present invention will be apparent from the foregoing description. While the method and system shown and described has been characterized as being preferred, it will be readily apparent that various changes and/or modifications could be made wherein without departing from the spirit and scope of the present invention as defined in the following claims.

What is claimed is:

1. A pad driver comprising:
means for selecting either functional or test data;
means for driving the selected data to a pad; and
means for transmitting the selected functional data to the driving means, the transmission of the selected functional data occurring substantially simultaneously with the receipt of the selected functional data.

2. The pad driver of claim 1 wherein the means for transmitting the selected functional data is a single stage circuit.

3. The pad driver of claim 2 wherein the driver circuitry is a pair of complementary transistors.

4. The pad driver of claim 3 wherein the pair of complementary transistors are PMOS and NMOS.

5. A pad driver comprising:
means for selecting either functional or test data; and
means for driving the selected data to a pad.

6. The pad driver of claim 5 further comprising:
means for transmitting the selected functional data to the driving means, the transmission of the selected functional data occurring substantially simultaneously with the receipt of the selected functional data.

7. The pad driver of claim 6 wherein the means for providing the selected functional data is a single stage circuit.

8. The pad driver of claim 7 wherein the driver circuitry is a pair of complementary transistors.

9. The pad driver of claim 8 wherein the pair of complementary transistors are PMOS and NMOS.

10. A method of driving data to a pad, the method comprising the steps of:
selecting either functional or test data;
driving, using a driver circuit, the selected data to the pad; and
transmitting the selected functional data to the driver circuit, the transmission of the selected functional data occurring substantially simultaneously with the receipt of the selected functional data.
